(19) United States
(12) Patent Application Publication
(10) Pub. No.: US 2003/0039806 A1
(43) Pub. Date: Feb. 27, 2003

(54) Wallpaper composition and method

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 09/886,731

(22) Filed: Jun. 21, 2001

Related U.S. Application Data
(62) Division of application No. 09/337,239, filed on Jun. 22, 1999, now abandoned.

(51) Int. Cl. B32B 3/00

(52) U.S. Cl. 428/172; 156/71; 428/156; 428/203

(57) ABSTRACT

A decorative wall covering produced from a transparent sheet of material and which is substantially water impermeable and stain resistant, and methods for decorating a wall with same. The decorative wall covering may be a laminated material containing at least two sheets of material, one sheet of which is substantially water impermeable and stain resistant. The sheet(s) of material from which the decorative wall covering is constructed may be textured, modified, printed, embossed and combinations thereof to provide the decorative pattern of the wall covering.

### CROSS REFERENCE TO RELATED APPLICATION

Not Applicable

### STATEMENT REGARDING FEDERALLY SPONSORED RESEARCH OF DEVELOPMENT

Not Applicable

### BACKGROUND OF THE INVENTION

1. Field of the Invention

The present invention relates generally to decorative wall covering and methods for producing same, and more particularly, but not by way of limitation, to substantially water impermeable, stain resistant wall covering and methods for producing same.

2. Brief Description of Prior Art

Wall coverings have been used for many years for decorative purposes. The wall coverings of the prior art have been produced by numerous methods and from a variety of materials such as vinyl, wood, fabric, and paper. The materials have been textured, printed and embossed on the front surface to provide a decorative design pattern for the wall covering. The other surface, or back surface, may be coated with adhesive, and typically a wallpaper paste is applied to the wall or the back surface of the material for adhesion of the wall covering to the wall.

The wall coverings of the prior art, however, are typically sensitive to water and various food and household items which might stain the material of the wall covering. In addition, the method used for cleaning the wall covering can adversely affect the color and pattern of the wall covering, and can even strip part of the material from the wall.

While the prior art methods for making decorative wall covering have been widely accepted, new and improved methods for making wall covering having improved durability qualities, such as water impermeability and stain resistance, are being sought. It is to such wall coverings and methods for producing same that the present invention is directed.

### SUMMARY OF THE INVENTION

The present invention relates to decorative wall coverings having improved water impermeability and stain resistance, therefore avoiding the disadvantages and defects in the prior art, and methods for producing same. In one aspect, the present invention relates to making laminated decorative wall coverings and methods for producing same. The decorative pattern of the laminated wall covering will be contained underneath a substantially transparent polymeric material through which water, food, and various household items will not be able to penetrate. This will allow for ease of cleanup and durability of the wall covering. In addition, the laminated wall covering will have a greater tear resistance than the prior art. This will allow for more shifting and adjusting of the wall covering after application to the wall so that the wall covering can be repositioned to match up patterns from one wall covering strip to the next.

The wall covering may be constructed from one sheet of transparent polymeric material or a laminated material containing two or more sheets of material wherein the upper sheet of material is a transparent polymeric material. Paper, cloth, foil, and polymeric film may be used for a lower sheet of material of the laminated wall covering. If desired, the surfaces of the wall covering may be modified to provide the decorative appearance of the wall covering, and alterations may be used in combination with one another.

An object of the present invention is to provide decorative wall covering produced from a transparent sheet of material and which is substantially water impermeable and stain resistant.

Another object of the present invention is to provide laminated decorative wall covering which is substantially water impermeable and stain resistant.

Another object of the present invention, while achieving the before-stated objects, is to provide methods for producing decorative wall coverings which are substantially water impermeable and stain resistant.

Other objects, features and advantages of the present invention will become apparent from the following detailed description when read in conjunction with the accompanying drawings and appended claims.

### BRIEF DESCRIPTION OF THE DRAWINGS

FIG. 1 is a pictorial representation of a laminated wall covering constructed in accordance with the present invention wherein a first sheet of substantially transparent material having a decorative pattern printed on a lower surface thereof is disposed adjacent and laminated to the upper surface of a second sheet of material.

FIG. 2 is a pictorial representation of a laminated wall covering constructed in accordance with the present invention wherein a sheet of material having a decorative pattern thereon is overlaid with a sheet of substantially transparent material.

FIG. 3 is a pictorial representation of a substantially transparent wall covering having a decorative pattern on its lower surface in accordance with the present invention.

FIG. 4 is a pictorial illustration of a person applying bonding material to the lower surface of the wall covering of the present invention.

FIG. 5 is a pictorial illustration of a person positioning the wall covering of the present invention on a wall.

### DESCRIPTION OF THE PREFERRED EMBODIMENTS

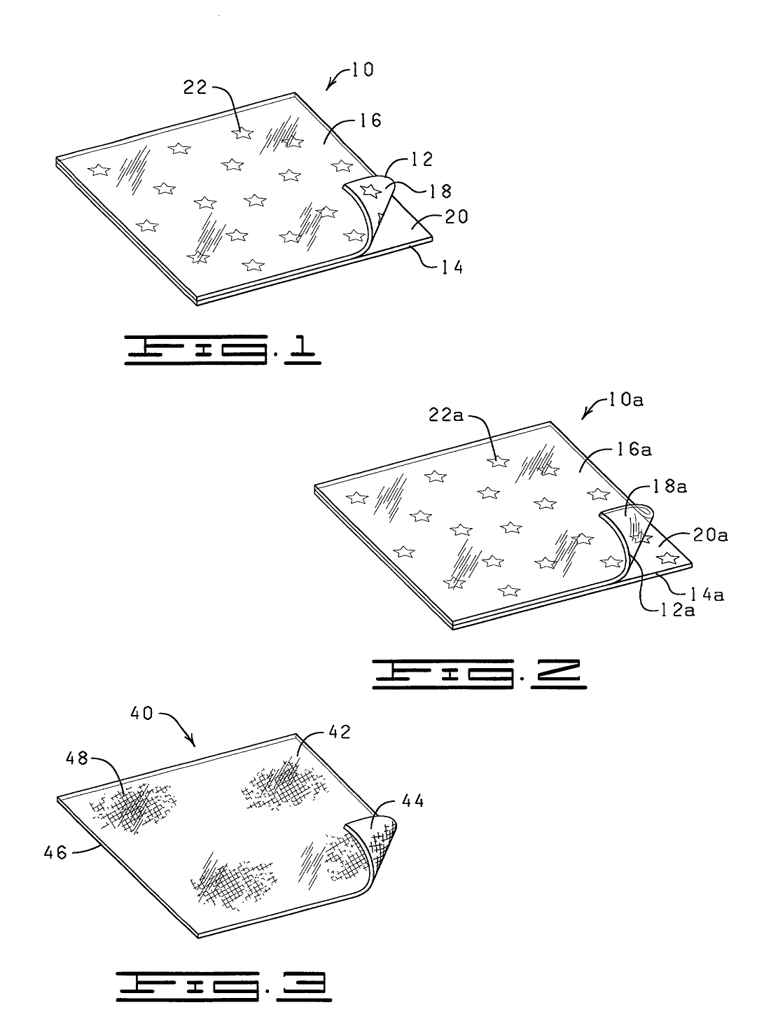

Shown in FIG. 1 and designated therein by the general reference numeral 10 is a substantially water impermeable, stain resistant laminated wall covering comprising a first or upper sheet of material 12 and a second or lower sheet of material 14. The first sheet of material 12 has an upper surface 16 and a lower surface 18. The second sheet of material 14 has an upper surface 20 and a lower surface 24 (FIG. 4).

The first sheet of material 12 has a thickness in a range of from about 0.1 mil to about 30 mils, preferably from about 0.1 mil to about 10 mils, and more preferably from about 0.4 mil to 0.9 mil. The first sheet of material 12 is constructed of a substantially transparent polymeric material. Examples of suitable substantially transparent polymeric materials which can be used as the first sheet of material 12 are a naturally occurring polymer such as, but not by way of limitation, cellophane, and a synthetic polymer. The term “synthetic polymer” as used herein means a thermoplastic resinous material, such as, but not by way of limitation, a man-made polymer such as, but not by way of limitation, polypropylene. These types of material are commercially available.

The second sheet of material 14 has a thickness in the range of from about 0.1 mil to about 30 mils, preferably from about 0.1 mil to about 10 mils, and more preferably from about 0.4 mil to about 0.9 mil. The second sheet of material 14 is constructed of any one of a group of materials comprising paper, synthetic paper, a naturally occurring polymer such as cellophane, a synthetic polymer, cloth, foil, metallized film, iridescent film and combinations thereof. These types of material are all commercially available.

The second sheet of material 14 may be constructed of a single layer of material or a plurality of layers of the same or different types of materials. When the second sheet of material 14 comprises more than one layer, the layers of material comprising the second sheet of material 14 may be laminated together or connected together by any method known in the art.

The term “synthetic paper” as used herein means a man-made paper such as, but not by way of limitation, Tyvek®. A synthetic paper as contemplated and described herein is relatively strong and is not as subject to tearing (substantially nontearable), as might be the case with paper or foil.

The first sheet of material 12 and the second sheet of material 14 are substantially the same size so that, when the first sheet of material 12 and the second sheet of material 14 are disposed adjacent each other, the two sheets are substantially aligned, and the laminated material lies flat. In operation, the first sheet of material 12 is placed adjacent the second sheet of material 14 so that the lower surface 18 of the first sheet of material 12 is disposed adjacent the upper surface 20 of the second sheet of material 14. The upper sheet of material 12 is laminated to the lower sheet of material 14 via a bonding material such that the transparent upper sheet of material 12 overlays the upper surface of the lower sheet of material 14.

The term “bonding material” when used herein means an adhesive, possibly a pressure sensitive adhesive, or a cohesive. Where the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” when used herein also means a lacquer, which may be applied to the sheet of material and, in this instance, heat, sound waves, or vibrations, also must be applied to effect the sealing of the lacquer.

The bonding material used to laminate the first sheet of material 12 and the second sheet of material 14 together may also be tinted or colored by using a dye, pigment or ink. In this manner, different coloring effects are provided, and the first sheet of material 12 and/or the second sheet of material 14 may be given a colored appearance by use of a colored bonding material. U.S. Pat. No. 5,147,706 entitled “Water Based Ink On Foil And/Or Synthetic Organic Polymer” issued to Kingman on Sep. 15, 1992 and which is hereby incorporated herein by reference describes an example of an ink which may be applied to the bonding material.

A bonding material may be disposed on the upper surface 20 of the second sheet of material 14 and/or on the lower surface 18 of the first sheet of material 12. The bonding material may be applied as strips, spots, geometric or non-geometric or asymmetric forms, and in any pattern. The colored bonding material may be applied to either sheet of material in such a way as to produce a decorative pattern. For example, a decorative design may be stamped on a sheet of material in the colored bonding material so that its application to the sheet of material enhances the decorative appearance of the wall covering.

Extrusion coating of the lower sheet of material rather than lamination to the upper sheet of transparent polymeric material is another option for producing substantially water impermeable and stain resistant wall covering; however, the method of lamination should produce a superior product to extrusion coating because it permits a thinner combination of materials and yet is stronger than the extrusion coated material. In addition, laminated products generally have a greater flexibility than do extrusion coating products.

In FIG. 1, the lower surface 18 of the upper sheet of material 12 is modified to provide a decorative pattern or design 22 which is visible through the substantially transparent upper sheet of material 12. In addition, although not specifically drawn, both sheets of material or a portion of both sheets of material may be modified to provide a decorative appearance which is visible through the upper surface 16 of the upper sheet of material 12 and provides the decorative design 22 of the wall covering 10.

The method of modifying the lower surface 18 of the upper sheet of material 12 may be texturing, printing, and/or embossing. Modification methods such as printing may require an ink or dye to provide the decorative pattern 22. An example of an ink which may be applied to the first sheet of material 12 of the substantially water impermeable, stain resistant laminated wall covering 10 is disclosed in U.S. Pat. No. 5,147,706 described immediately above. Alternatively, methods such as texturing and embossing may require depressions and impressions to be imprinted on the upper sheet of material 12. Each of the above-named modifications may occur singly, that is, the sheet of material 12 is textured only or printed only, and the modifications may occur in any combination, that is, the sheet of material 12 is both printed and embossed, or one sheet of a wall covering is embossed while the other sheet of a wall covering is printed and/or textured. The combination of modifications to enhance the design pattern 22 may be accomplished by placing the modifications either in or out of register with one another. The modifications may be present on a portion of the sheet of material 12 or on the entire sheet of material 12.

The modification of the sheet of material 12 also includes modifying at least one surface of the sheet of material 12 to simulate the appearance of wood, cloth, paper, or fibers; this modification may also be used singly and in combination with other modifications.

Shown in FIG. 2 and designated therein by the general reference numeral 10a is another embodiment of a substantially water impermeable, stain resistant laminated wall covering comprising a first or upper sheet of material 12a and a second or lower sheet of material 14a. The first sheet of material 12a has an upper surface 16a and a lower surface 18a. The second sheet of material 14a has an upper surface 20a and a lower surface (not shown).

The first sheet of material 12a has a thickness in a range of from about 0.1 mil to about 30 mils, preferably from about 0.1 mil to about 10 mils, and more preferably from about 0.4 mil to 0.9 mil. The first sheet of material 12a is constructed of a substantially transparent polymeric material. Examples of suitable substantially transparent polymeric materials which can be used as the first sheet of material 12a are a naturally occurring polymer such as, but not by way of limitation, cellophane, and a synthetic polymer such as, but not by way of limitation, polypropylene. These types of material are commercially available.

The second sheet of material 14a has a thickness in the range of from about 0.1 mil to about 30 mils, preferably from about 0.1 mil to about 10 mils, and more preferably from about 0.4 mil to about 0.9 mil. The second sheet of material 14a is constructed of any one of a group of materials comprising paper, synthetic paper, a naturally occurring polymer such as cellophane, a synthetic polymer, cloth, foil, metallized film, iridescent film and combinations thereof. These types of material are all commercially available.

The second sheet of material 14a may be constructed of a single layer of material or a plurality of layers of the same or different types of materials. When the second sheet of material 14a comprises more than one layer, the layers of material comprising the second sheet of material 14a may be laminated together or connected together by any method known in the art.

The first sheet of material 12a and the second sheet of material 14a are substantially the same size so that, when the first sheet of material 12a and the second sheet of material 14a are disposed adjacent each other, the two sheets are substantially aligned, and the laminated material lies flat. In operation, the first sheet of material 12a is placed adjacent the second sheet of material 14a so that the lower surface 18a of the first sheet of material 12a is disposed adjacent the upper surface 20a of the second sheet of material 14a. The upper sheet of material 12a is laminated to the lower sheet of material 14a via a bonding material such that the transparent upper sheet of material 12a overlays the upper surface of the lower sheet of material 14a.

The bonding material used to laminate the first sheet of material 12a and the second sheet of material 14a together may also be tinted or colored by using a dye, pigment or ink. In this manner, different coloring effects are provided, and the first sheet of material 12a and/or the second sheet of material 14a may be given a colored appearance by use of a colored bonding material. U.S. Pat. No. 5,147,706, described immediately above, discloses an example of an ink which may be applied to the bonding material.

A bonding material may be disposed on the upper surface 20a of the second sheet of material 14a and/or on the lower surface 18a of the first sheet of material 12a. The bonding material may be applied as strips, spots, geometric or non-geometric or asymmetric forms, and in any pattern. The colored bonding material may be applied to either sheet of material in such a way as to produce a decorative pattern. For example, a decorative design could be stamped on a sheet of material in the colored bonding material so that its application to the sheet of material enhances the decorative appearance of the wall covering.

In FIG. 2, the upper surface 20a of the lower sheet of material 14a is modified to provide a decorative pattern or design 22a which is visible through the substantially transparent upper sheet of material 12a. In addition, although not specifically drawn, both sheets of material or a portion of both sheets of material may be modified to provide a decorative appearance which is visible through the upper surface 16a of the upper sheet of material 12a and provides the decorative design 22a of the wall covering 10a.

The method of modifying the upper surface 20a of the lower sheet of material 14a may be texturing, printing, and/or embossing. The modification methods such as printing may require an ink or dye to provide the decorative pattern 22a. An example of an ink which may be applied to the second sheet of material 14a of the substantially water impermeable, stain resistant laminated wall covering 10a is disclosed in U.S. Pat. No. 5,147,706 described immediately above. Alternatively, modification methods such as texturing and embossing may require depressions and impressions to be imprinted on the lower sheet of material 14a. Each of the above-named modifications may occur singly, that is, the sheet of material 14a is textured only or printed only, and the modifications may occur in any combination, that is, the sheet of material 14a is both printed and embossed, or one sheet of a wall covering is embossed while the other sheet of a wall covering is printed. The combination of modifications to enhance the design pattern 22a may be accomplished by placing the modifications either in or out of register with one another. The modifications may be present on a portion of the sheet of material 14a or on the entire sheet of material 14a.

The modification of the sheet of material 14a also includes modifying at least one surface of the sheet of material 14a to simulate the appearance of wood, cloth, paper, or fibers; this modification may also be used singly and in combination with other alterations.

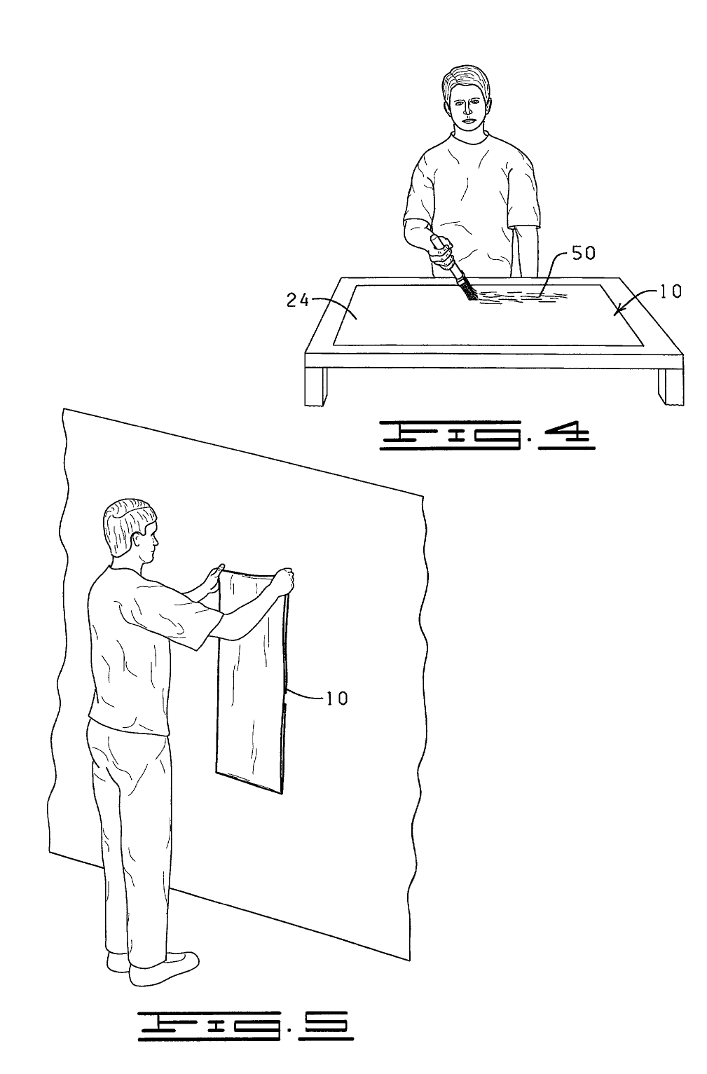

Shown in FIG. 3 and designated therein by the general reference numeral 40 is a substantially water impermeable and stain resistant wall covering constructed from a sheet of substantially transparent polymeric material 46. The sheet of material has an upper surface 42 and a lower surface 44. The sheet of material 46 has a thickness in a range of from about 0.1 mil to about 30 mils. Examples of suitable substantially transparent polymeric materials which can be used as the first sheet of material 46 are a naturally occurring polymer such as, but not by way of limitation, cellophane, and a synthetic polymer such as, but not by way of limitation, polypropylene. These types of material are commercially available.

The lower surface 44 of the wall covering 40 may be modified to provide a decorative pattern or design 48 which is visible through the upper surface 42 of the wall covering 40 and provides the decorative design 48 of the wall covering 40. The method of modifying the sheet of material 46 may be texturing, printing, and/or embossing. The modification methods such as printing may require an ink or dye to provide the decorative pattern 48. An example of an ink which may be applied to the sheet of material 46 is described in U.S. Pat. No. 5,147,706 described immediately above. Alternatively, modification methods such as texturing and embossing may require depressions and impressions to be imprinted on the sheet of material 46.

The modifications may occur singly, that is, the sheet of material 46 is textured only or printed only, and the modifications may occur in any combination, that is, the sheet of material 46 is both printed and embossed. The combination of modifications to enhance the design pattern 48 may be accomplished by placing the modifications either in or out of register with one another. The modifications may be present on a portion of the sheet of material 46 or on the entire sheet of material 46.

The modification of the sheet of material 46 also includes modifying at least one surface of the sheet of material 46 to simulate the appearance of wood, cloth, paper, or fibers; this modification may be used singly and in combination with other modifications.

FIG. 4 schematically illustrates a person applying bonding material 50 to the lower surface 24 of the wall covering 10 herein before described with reference to FIG. 1 in accordance with the present invention. Although not specifically shown, the wall covering can be produced from any of the methods described above, and may also be the substantially transparent polymeric wall covering 40 or the laminated wall covering 10a. The bonding material 50 may be tinted or colored by using a dye, pigment or ink. In this manner, different coloring effects are provided, and the laminated wall covering 10 may be given a colored appearance by use of a colored bonding material. U.S. Pat. No. 5,147,706, described immediately above, discloses an ink which can be applied to the bonding material 50 to obtain a colored bonding material.

In addition to application of the bonding material 50 to the lower surface 24 of the laminated wall covering 10, the bonding material 50 may also be applied to the wall. The bonding material 50 may be applied to the laminated wall covering, the wall, or both in such a way as to provide continuous coverage to prevent bubbles from forming.

FIG. 5 schematically illustrates a person positioning the laminated wall covering 10 on a wall in accordance with the present invention. Although not specifically shown, the wall covering may also be the laminated wall covering 10a or the substantially transparent wall covering 40. The laminated wall covering 10 should be positioned and aligned on the portion of the wall to be decorated so that the decorative appearance 22 which is visible through the upper sheet 12 of the laminated wall covering 10 is visually displayed on the wall. The wall covering 10 is bondingly connected to the wall by the bonding material 50, which can be present on the lower surface of the wall covering 10, the wall, or portions of both. Another advantage of the wall covering 10 of the present invention over the prior art is the greater ability to shift or adjust the wall covering on the wall. This enhances the ability to reposition the wallpaper while matching up patterns from one wall covering strip to the next.

After positioning the wall covering 10 on the wall, the wall covering 10 is rolled and/or adjusted so as to be properly positioned by methods well known in the art. This will provide a smooth, bubble-free wall covering with greater water impermeability and stain resistance than the wall coverings of the prior art.

Changes may be made in the embodiments of the invention described herein, or in parts or elements of the embodiments described herein, or in the steps or sequence of steps of the methods described herein, without departing from the spirit and/or scope of the invention as defined in the following claims.

What is claimed is:

1. A method for decorating a wall, comprising:
providing a sheet of substantially transparent polymeric material having an upper surface and a lower surface, the lower surface disposable adjacent the wall to be decorated, at least a portion of the lower surface of the sheet of substantially transparent polymeric material being textured, modified, printed, embossed and combinations thereof to provide the sheet of material with a decorative appearance which is visible through the upper surface thereof;
applying a bonding material to at least one of the lower surface of the sheet of material and a portion of the wall; and
positioning the lower surface of the sheet of material adjacent the portion of the wall to be decorated such that the sheet of material is bondingly connected thereto while maintaining visual display of the decorative appearance of the sheet of material through the upper surface thereof and thereby provide a wall covering having a decorative appearance which is substantially water impermeable and stain resistant.

2. The method for decorating a wall of claim 1 wherein, in the step of providing the sheet of material, at least a portion of the lower surface of the sheet of material is printed to provide the sheet of material with a printed design which provides the decorative appearance of the sheet of material.

3. The method for decorating a wall of claim 2 wherein, in the step of providing the sheet of material, at least a portion of the lower surface of the sheet of material is embossed to provide a sheet of material with an embossed design and wherein the embossed design in combination with the printed design provide the sheet of material with the decorative appearance.

4. The method for decorating a wall of claim 3 wherein, in the step of providing the sheet of material, at least a portion of the embossed design and a portion of the printed design are in register with one another.

5. The method for decorating a wall of claim 3 wherein, in the step of providing the sheet of material, at least a portion of the embossed design and a portion of the printed design are out of register with one another.

6. The method for decorating a wall of claim 1 wherein, in the step of providing the sheet of material, at least a portion of the lower surface of the sheet of material is embossed to provide the sheet of material with an embossed design which provides the decorative appearance of the sheet of material.

7. The method for decorating a wall of claim 1 wherein, in the step of applying a bonding material to at least one of the lower surface of the sheet of material and a portion of the wall, the bonding material is colored to enhance the decorative appearance of the sheet of material.

8. A method for decorating a wall, comprising:
providing a sheet of substantially transparent polymeric material having an upper surface and a lower surface, the lower surface disposable adjacent the wall to be decorated, the lower surface of the sheet of substantially transparent polymeric material being modified to simulate the appearance of one of wood, cloth, paper and fibers such that the appearance is visible through the upper surface thereof;
applying a bonding material to at least one of the lower surface of the sheet of material and a portion of the wall; and
positioning the lower surface of the sheet of material adjacent the portion of the wall to be decorated such that the sheet of material is bondingly connected thereto while maintaining visual display of the decorative appearance of the sheet of material through the upper surface thereof and thereby provide a wall covering having a decorative appearance which is substantially water impermeable and stain resistant.

9. The method for decorating a wall of claim 8 wherein, in the step of applying a bonding material to at least one of the lower surface of the sheet of material and a portion of the wall, the bonding material is colored to enhance the decorative appearance of the sheet of material.

10. A method for decorating a wall with a substantially water impermeable and stain resistant wall covering, comprising:
providing a wall covering having a decorative design, the wall covering comprising:
a first sheet of material having an upper surface and a lower surface, at least a portion of the upper surface of the first sheet of material being textured, modified, printed, embossed and combinations thereof to provide the sheet of material with a decorative pattern, and
a second sheet of substantially transparent polymeric material having an upper surface and a lower surface, the lower surface of the second sheet of material laminated to the upper surface of the first sheet of material such that the decorative pattern provided on the upper surface of the first sheet of material is visible through the second sheet of material;
applying a bonding material to at least one of the wall covering and a portion of the wall; and
positioning the wall covering adjacent the portion of the wall to be decorated such that the wall covering is bondingly connected to the wall while maintaining visual display of the decorative pattern applied to the upper surface of the first sheet of material through the second sheet of material of the wall covering.

11. The method for decorating a wall of claim 10 wherein, in the step of providing a wall covering having a decorative design, the first sheet of material is constructed from the group consisting of paper, synthetic paper, cloth, foil, metallized film and iridescent film.

12. The method for decorating a wall of claim 10 wherein, in the step of providing a wall covering having a decorative design, at least a portion of the upper surface of the first sheet of material is printed to provide the first sheet of material with a printed design which is visible through the second sheet of material so as to provide the decorative design of the wall covering.

13. The method for decorating a wall of claim 12 wherein, in the step of providing a wall covering having a decorative design, at least a portion of the upper surface of the first sheet of material is embossed to provide the first sheet of material with an embossed design which cooperates with the printed design to provide the decorative design of the wall covering which is visible through the second sheet of material.

14. The method for decorating a wall of claim 13 wherein, in the step of providing a wall covering having a decorative design, at least a portion of the embossed design and a portion of the printed design are in register with one another.

15. The method for decorating a wall of claim 13 wherein, in the step of providing a wall covering having a decorative design, at least a portion of the embossed design and a portion of the printed design are out of register with one another.

16. The method for decorating a wall of claim 10 wherein, in the step of providing a wall covering having a decorative design, at least a portion of the upper surface of the first sheet of material is embossed to provide the first sheet of material with an embossed design which is visible through the second sheet of material so as to provide the decorative design of the wall covering.

17. The method for decorating a wall of claim 10 wherein, in the step of applying a bonding material to at least one of the wall covering and a portion of the wall, the bonding material is colored to enhance the decorative appearance of the wall covering.

18. A method for decorating a wall with a substantially water impermeable and stain resistant wall covering, comprising:
providing a wall covering having a decorative design, the wall covering comprising:
a first sheet of material having an upper surface and a lower surface; and
a second sheet of substantially transparent polymeric material having an upper surface and a lower surface, at least a portion of one of the upper surface of the first sheet of material and the lower surface of the second sheet of material being textured, modified, printed, embossed and combinations thereof to provide the sheet of material with a decorative pattern, the lower surface of the second sheet of material laminated to the upper surface of the first sheet of material such that the decorative pattern is visible through the second sheet of material;
applying a bonding material to at least one of the wall covering and a portion of the wall; and
positioning the wall covering adjacent the portion of the wall to be decorated such that the wall covering is bondingly connected to the wall while maintaining visual display of the decorative pattern through the upper surface of the second sheet of material.

19. The method for decorating a wall of claim 18 wherein, in the step of providing a wall covering having a decorative design, at least a portion of the upper surface of the first sheet of material and the lower surface of the second sheet of material is printed to provide a printed design which is visible through the upper surface of the second sheet of material so as to provide the decorative design of the wall covering.

20. The method for decorating a wall of claim 19 wherein, in the step of providing a wall covering having a decorative design, at least a portion of the upper surface of the first sheet of material and the lower surface of the second sheet of material is embossed to provide an embossed design which cooperates with the printed design to provide the decorative design of the wall covering which is visible through the second sheet of material.

21. The method for decorating a wall of claim 20 wherein, in the step of providing a wall covering having a decorative design, at least a portion of the embossed design and a portion of the printed design are in register with one another.

22. The method for decorating a wall of claim 20 wherein, in the step of providing a wall covering having a decorative design, at least a portion of the embossed design and a portion of the printed design are out of register with one another.

23. The method for decorating a wall of claim 18 wherein, in the step of providing a wall covering having a decorative design, at least a portion of the upper surface of the first sheet of material and the lower surface of the second sheet of material is embossed to provide an embossed design which is visible through the upper surface of the second sheet of material so as to provide the decorative design of the wall covering.

24. The method of claim 18 wherein, in the step of providing a wall covering having a decorative design, the first sheet of material is constructed from the group consisting of paper, synthetic paper, cloth, foil, metallized film and iridescent film.

25. The method of claim 18 wherein, in the step of applying a bonding material to at least one of the wall covering and a portion of the wall, and wherein the bonding material is colored to enhance the decorative appearance of the wall covering.

26. A method for decorating a wall, comprising:
providing a laminated wall covering comprising:
a first sheet of material having an upper surface and a lower surface; and
a second sheet of substantially transparent polymeric material having an upper surface and a lower surface, the second sheet of material laminated to the first sheet of material, at least a portion of one of the upper surface of the first sheet of material and the lower surface of the second sheet of material being modified whereby the laminated wall covering is provided with a decorative appearance simulating the appearance of a material selected from the group consisting of wood, cloth, paper, fibers and combinations thereof, such that the decorative appearance is visible through the upper surface of the second sheet of material;
applying a bonding material to at least one of the wall covering and a portion of the wall; and
positioning the wall covering adjacent the portion of the wall to be decorated such that the wall covering is bondingly connected to the wall while maintaining visual display of the decorative appearance through the second sheet of material of the wall covering.

27. The method for decorating a wall of claim 26 wherein, in the step of providing a laminated wall covering, at least a portion of one of the upper surface of the first sheet of material and the lower surface of the second sheet of material is printed to provide a printed design which produces the decorative appearance of the wall covering.

28. The method for decorating a wall of claim 27 wherein, in the step of providing a laminated wall covering, at least a portion of one of the upper surface of the first sheet of material and the lower surface of the second sheet of material is embossed to provide an embossed design which produces the decorative appearance of the wall covering.

29. The method for decorating a wall of claim 28 wherein, in the step of providing a laminated wall covering, at least a portion of the embossed design and at least a portion of the printed design are in a register with one another.

30. The method for decorating a wall of claim 28 wherein, in the step of providing a laminated wall covering, at least a portion of the embossed design and at least a portion of the printed design are out of register with one another.

31. The method for decorating a wall of claim 28 wherein the first sheet of material is laminated to the second sheet of substantially transparent polymeric material with a colored bonding material to enhance the decorative appearance of the laminated wall covering.

32. The method for decorating a wall of claim 26 wherein, in the step of providing a laminated wall covering, at least a portion of one of the upper surface of the first sheet of material and the lower surface of the second sheet of material is embossed to provide an embossed design which produces the decorative appearance of the wall covering.

33. The method for decorating a wall of claim 26 wherein, in the step of applying a bonding material to at least one of the laminated wall covering and a portion of the wall, the bonding material is colored to enhance the decorative appearance of the laminated wall covering.

34. A decorative wall covering which is substantially water impermeable and stain resistant, comprising:
a sheet of substantially transparent polymeric material having an upper surface and a lower surface, the lower surface disposable adjacent a wall to be decorated, at least a portion of the lower surface of the sheet of substantially transparent polymeric material being textured, modified, printed, embossed and combinations thereof to provide the sheet of material with a decorative pattern visible through the upper surface thereof.

35. A substantially water impermeable and stain resistant wall covering comprising:
a first sheet of material having an upper surface and a lower surface, at least a portion of the upper surface of the first sheet of material being textured, modified, printed, embossed and combinations thereof to provide the first sheet of material with a decorative pattern; and
a second sheet of substantially transparent polymeric material having an upper surface and a lower surface, the second sheet of material laminated to the first sheet of material such that the decorative pattern provided on the upper surface of the first sheet of material is visible through the second sheet of material.

36. The substantially water impermeable and stain resistant wall covering of claim 35 wherein the first sheet of material if constructed of one of paper, synthetic paper, cloth, foil, metallized film, and iridescent film.

37. The substantially water impermeable and stain resistant wall covering of claim 35 wherein in the second sheet of material is laminated to the upper surface of the first sheet of material with a colored bonding material.

38. A substantially water impermeable and stain resistant wall covering, comprising:
a first sheet of material having an upper surface and a lower surface; and
a second sheet of substantially transparent polymeric material having an upper surface and a lower surface, at least a portion of one of the upper surface of the first sheet of material and the lower surface of the second sheet of material being textured, modified, printed, embossed and combinations thereof to provide such sheet of material with a decorative pattern, the second sheet of material laminated to the first sheet of material such that the decorative pattern is visible through the second sheet of material.

39. The substantially water impermeable and stain resistant wall covering of claim 38 wherein the second sheet of material is laminated to the first sheet of material with a colored bonding material.

40. The substantially water impermeable and stain resistant wall covering of claim 38 wherein the first sheet of material is constructed of one of paper, synthetic paper, cloth, foil, metallized film and iridescent film.

41. The substantially water impermeable and stain resistant wall covering of claim 38 wherein at least a portion of one of the upper surface of the first sheet of material and the lower surface of the second sheet of material being textured, modified, printed, embossed and combinations thereof to provide such sheet of material with a decorative pattern, the lower surface of the sheet of substantially transparent polymeric material being modified to simulate the appearance of a material selected from the group consisting of wood, cloth, paper, fibers and combinations thereof such that the appearance is visible through the second sheet of material.

42. A substantially water impermeable and stain resistant wall covering having a decorative design, the wall covering comprising:
a first sheet of material having an upper surface and a lower surface;
a second sheet of substantially transparent polymeric material having an upper surface and a lower surface, the lower surface of the sheet of substantially transparent polymeric material being disposed adjacent the upper surface of the first sheet of material; and
a colored bonding material disposed on at least one of the upper surface of the first sheet of material and the lower surface of the second sheet of material for bondingly connecting the first sheet of material to the second sheet of material to provide the decorative design of the wall covering whereby the decorative design is visible through the second sheet of material.

43. The wall covering of claim 42 wherein the first sheet of material is constructed of one of paper, synthetic paper, cloth, foil, metallized film and iridescent film. 44. A substantially water impermeable and stain resistant wall covering, comprising:
a first sheet of material having an upper surface and a lower surface; and
a second sheet of substantially transparent polymeric material having an upper surface and a lower surface, at least a portion of one of the upper surface of the first sheet of material and the lower surface of the second sheet of material being modified to provide the wall covering with a decorative pattern simulating the appearance of a material selected from the group consisting of wood, cloth, paper, fibers and combinations thereof, the second sheet of material laminated to the first sheet of material such that the decorative pattern is visible through the second sheet of material.
